(19) United States
(12) Patent Application Publication
(10) Pub. No.: US 2015/0009176 A1
(43) Pub. Date: Jan. 8, 2015

(54) ELECTRONIC DEVICE

(71) Applicant: Panasonic Corporation, Osaka (JP)

(72) Inventors: Masahiro INATA, Hyogo (JP); Yusuke ADACHI, Osaka (JP); Ryo OKUMURA, Osaka (JP)

(21) Appl. No.: 14/328,771

(22) Filed: Jul. 11, 2014

Related U.S. Application Data
(63) Continuation of application No. PCT/JP2013/000649, filed on Feb. 6, 2013.

(30) Foreign Application Priority Data
Oct. 9, 2012 (JP) 2012-223894

(51) Int. Cl. G06F 3/041; G06F 3/044

(52) U.S. Cl. CPC G06F 3/0412; G06F 3/044
USPC 345/174

(57) ABSTRACT

An electronic device 100 includes a display part 160, a panel member 130, a vibration part 140, and an adhesive part 150. The panel member 130 is a member arranged so as to face the display part 160 and touched by a user. The vibration part 140 is attached to a face of the panel member 130 facing the display part 160, and causes the panel member 130 to vibrate. The adhesive part 150 is provided between the display part 160 and the panel member 130 so as to cover the vibration part 140, and bonds the display part 160 and the panel member 130 together.

### BACKGROUND

1. Field

The present disclosure relates to electronic devices that generate vibration in accordance with a touch operation performed by a user, for example.

2. Description of the Related Art

There have been known technologies for providing, in an electronic device in which a touch panel is arranged on a display surface, a user with tactile sensation by causing the touch panel to vibrate, in order to improve operability for the user.

For example, Patent Literature 1 discloses a device which provides a user with tactile sensation, by generating vibration on a touch panel by applying a voltage to a piezoelectric element fixed to the touch panel.

Patent Literature 1: Japanese Laid-Open Patent Publication No. 2005-222326

### SUMMARY

For example, mobile electronic devices often employing a touch panel are used in severe use environments compared with electronic devices set in offices or the like, and are required to have dust-proof/drip-proof performance, in particular. However, the technology disclosed in Patent Literature 1 does not take dust-proof/drip-proof performance into consideration in particular.

Therefore, the present disclosure provides an electronic device that has good dust-proof/drip-proof performance for a vibration part, and that can present a variety of tactile sensation in accordance with a touch operation performed by the user.

An electronic device according to the present disclosure includes: a display part; a panel member arranged so as to face the display part and touched by a user; a vibration part attached to the display part side of the panel member or to the panel member side of the display part, and configured to cause the panel member to vibrate; and an adhesive part provided between the display part and the panel member so as to cover the vibration part, and bonding the display part and the panel member together.

The electronic device according to the present disclosure has good dust-proof/drip-proof performance for the vibration part, and can present a variety of tactile sensation in accordance with a touch operation performed by the user.

### BRIEF DESCRIPTION OF THE DRAWINGS

FIG. 1 is a perspective view showing an overall structure of an electronic device of embodiment 1.

FIG. 2 is an exploded perspective view of the electronic device of embodiment 1.

FIG. 3 is a cross-sectional view of the electronic device of embodiment 1.

FIG. 4 is a block diagram of the electronic device of embodiment 1.

FIG. 5(a) is a schematic diagram showing an example of a vibration pattern of a vibration part of embodiment 1, and FIG. 5(b) is a schematic diagram showing another example of a vibration pattern of the vibration part of embodiment 1.

FIG. 6 is a cross-sectional view of an electronic device of embodiment 2.

FIG. 7 is a cross-sectional view of an electronic device of embodiment 3.

### DETAILED DESCRIPTION

Hereinafter, embodiments will be described with reference to the drawings as appropriate. However, there will be instances in which detailed description beyond what is necessary is omitted. For example, detailed description of subject matter that is previously well-known, as well as redundant description of components that are substantially the same will in some cases be omitted. This is to prevent the following description from being unnecessarily lengthy, in order to facilitate understanding by a person of ordinary skill in the art.

The inventors provide the following description and the accompanying drawings in order to allow a person of ordinary skill in the art to sufficiently understand the present disclosure, and the description and the drawings are not intended to restrict the subject matter of the scope of the patent claims.

### Embodiment 1

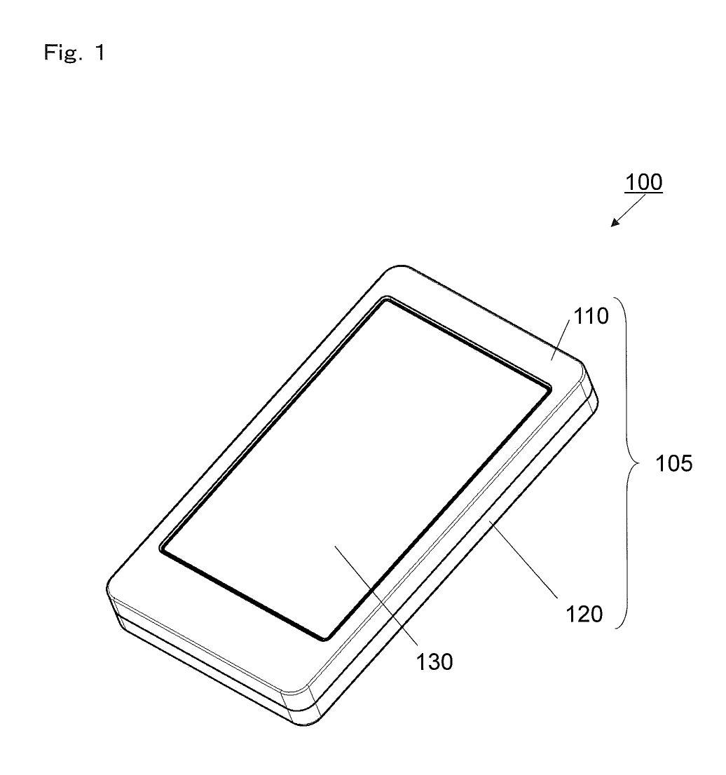

Hereinafter, embodiment 1 will be described with reference to FIGS. 1 to 5.

<Overall Structure of Electronic Device>

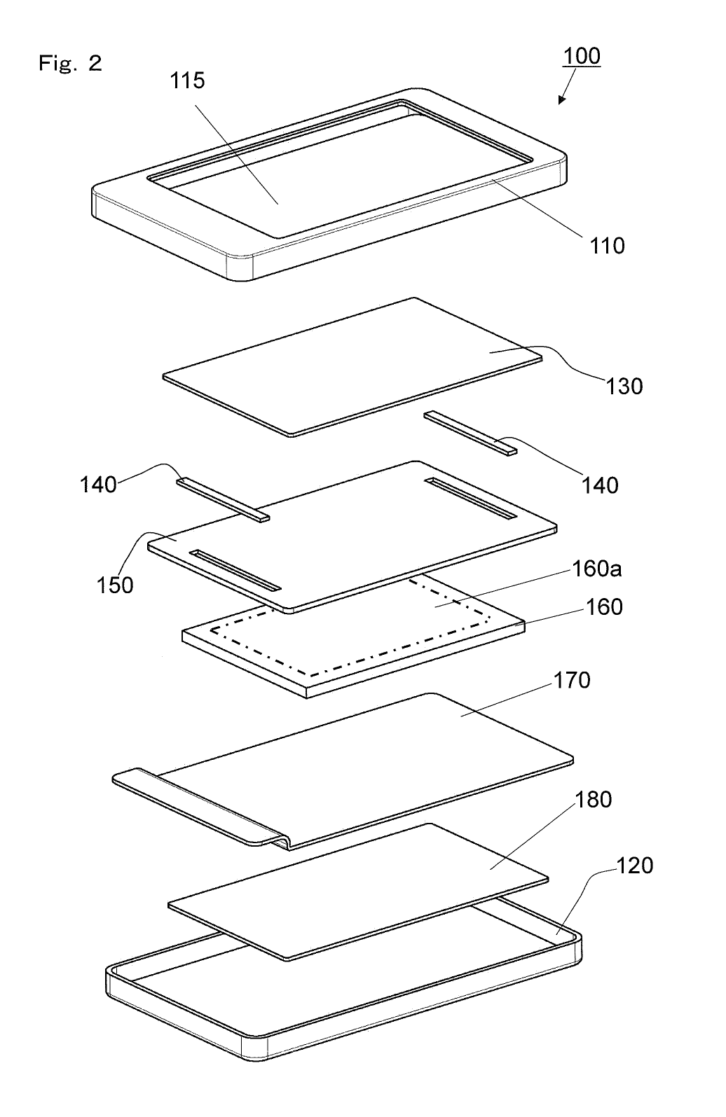

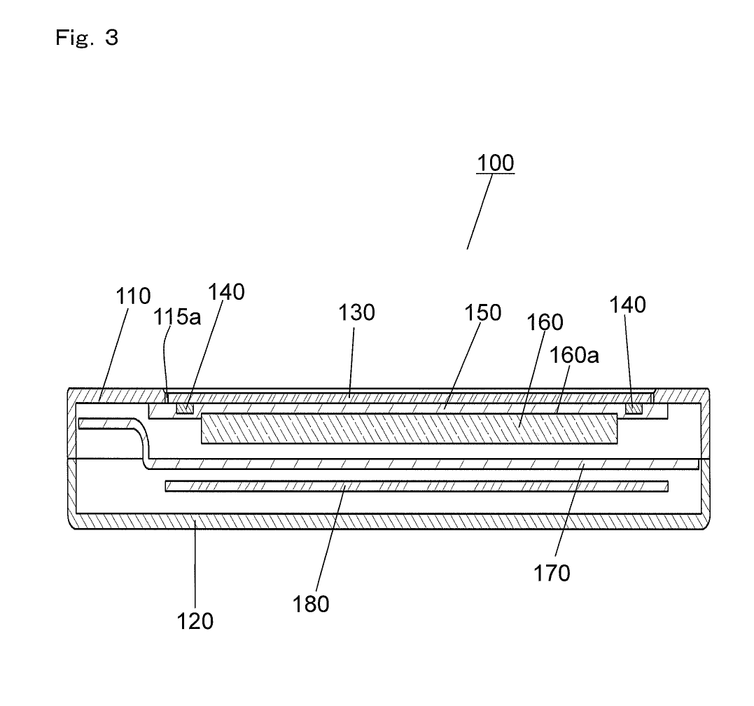

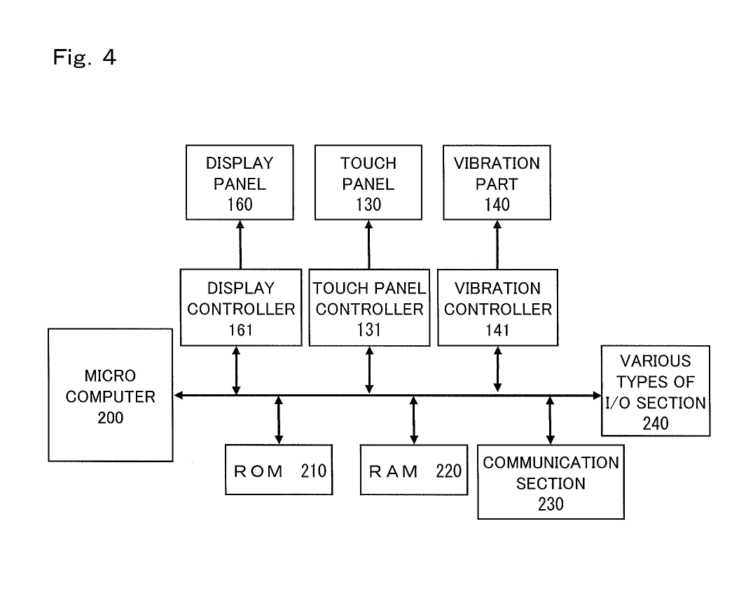

First, an overall structure of an electronic device 100 will be described with reference to FIG. 1 to FIG. 4. FIG. 1 is a perspective view showing an overall structure of the electronic device 100 of the present embodiment. FIG. 2 is an exploded perspective view of the electronic device 100 of the present embodiment. FIG. 3 is a cross-sectional view of the electronic device 100 of the present embodiment. FIG. 4 is a block diagram of the electronic device 100 of the present embodiment.

As shown in FIG. 1, the electronic device 100 includes an upper housing 110, a lower housing 120, and a touch panel 130. The upper housing 110 and the lower housing 120 are integrally coupled with each other with screws or the like, thereby forming a housing 105 of the electronic device 100. Below the touch panel 130, a display panel 160 (FIG. 2) is provided.

A user performs a touch operation of touching the touch panel 130 using a finger or a pen with respect to the contents displayed on the display panel 160, thereby operating the electronic device 100. The display panel 160 is an example of a display part. The touch panel 130 is an example of a panel member to be touched by the user.

As shown in FIG. 2, the electronic device 100 includes the display panel 160, the touch panel 130 arranged so as to cover the display panel 160, vibration parts 140 which cause the touch panel 130 to vibrate, an adhesive layer 150 (adhesive part) which bonds the touch panel 130 and the display panel 160 together. The adhesive layer 150 may further bond the vibration parts 140 and the touch panel 130 together. The adhesive layer 150 is an example of an adhesive part. In FIG. 2, the adhesive layer 150 is shown as a plate-like sheet member for convenience, but the adhesive layer 150 may be a gel-like member. For example, the adhesive layer 150 is formed by: applying an adhesive on the rear face of the touch panel 130 to which the vibration parts 140 have been bonded in advance; overlaying the display panel 160 on the adhesive; and then curing the adhesive. In the adhesive layer 150 shown in FIG. 2, grooves appear at the respective positions where the vibration parts 140 have been removed from the cured adhesive layer 150.

In the upper housing 110, a display window 115 is formed. The user can operate the touch panel 130 through the display window 115.

The touch panel 130 is arranged so as to face the display panel 160. The touch panel 130 is an example of a panel member to be touched by the user. The touch panel 130 is a touch panel of an electrostatic type, a resistive film type, or an optical type. The touch panel 130 can detect a touch position of the user. The touch panel 130 is controlled by a touch panel controller 131 (FIG. 4). A microcomputer 200 (FIG. 4) can obtain information of the touch position of the user, via the touch panel controller 131.

The vibration parts 140 are attached to a face of the touch panel 130 facing the display panel 160. Accordingly, by driving the vibration parts 140, it is possible to cause the touch panel 130 to vibrate. Accordingly, when the user operates the touch panel 130, the user can be provided with tactile sensation through vibration.

The display panel 160 is a display panel such as a liquid crystal display, an organic EL display, electronic paper, a plasma display, or the like. The display panel 160 is controlled by a display controller 161 (FIG. 4). The microcomputer 200 causes, via the display controller 161 (FIG. 4), the display panel 160 to display a given image to be presented to the user.

A frame 170 supports a circuit board 180 and is fixed to the lower housing 120 with screws or the like. To the circuit board 180, the touch panel 130, the display panel 160, and the vibration parts 140 are electrically connected. The touch panel 130, the display panel 160, and the vibration parts 140 are controlled by the microcomputer 200 provided on the circuit board 180.

In the present embodiment, the touch panel 130 is an externally-mounted touch panel separated from the display panel 160. However, the present disclosure is not limited thereto. The touch panel 130 may be a built-in touch panel included in the display panel 160. For example, the touch panel 130 may be an in-cell touch panel or the like that has a touch panel function integrated inside the liquid crystal panel. Alternatively, the touch panel 130 may be an on-cell touch panel. In the case of a built-in touch panel, instead of the touch panel 130, a mere protection panel that does not have a detecting function of a touch position will serve as a panel member to be touched by the user.

<Description of Adhesive Layer>

The adhesive layer 150 bonds the touch panel 130 and the display panel 160 together, by a bonding method called optical bonding. Here, the display panel 160 includes a display surface 160a (display region) on which to display information such as characters and images. The adhesive layer 150 is formed so as to cover at least the entirety of the display surface 160a. In the present embodiment, the entire region of the front face (face on the touch panel 130 side) of the display panel 160 is covered with the adhesive layer 150, and the display panel 160 is affixed to the touch panel 130.

The adhesive layer 150 is formed from, for example, a baseless double-faced adhesive sheet, an optical elastomeric resin which cures under ultraviolet rays, or the like. Further, the adhesive layer 150 is formed from an optically transparent material that allows light emitted from the display surface 160a to pass therethrough. Accordingly, information such as characters and images displayed on the display surface 160a can be viewed by the user.

The adhesive layer 150 will be further described with reference to FIG. 3.

As shown in FIG. 3, the adhesive layer 150 is formed so as to cover each vibration part 140 attached to the touch panel 130. Each vibration part 140 is embedded in the adhesive layer 150. This can eliminate exposure of each vibration part 140, and can prevent breakage of the vibration part 140 due to entry of water drops. The adhesive layer 150 plays a role of a seal for dust-proof/drip-proof performance for each vibration part 140.

Further, as shown in FIG. 3, the adhesive layer 150 bonds the upper housing 110 and the touch panel 130 together in an outer peripheral portion of the touch panel 130. In other words, the adhesive layer 150 bonds the upper housing 110 and the touch panel 130 together, in a peripheral portion of the display window 115 of the upper housing 110.

Accordingly, a gap 115a between the outer peripheral portion of the touch panel 130 and the upper housing 110 is closed by the adhesive layer 150. Accordingly, without newly providing a component for dust-proof/drip-proof performance, entry of dust and water drops from the gap 115a into the inside of the electronic device 100 can be prevented.

<Functional Configuration of Electronic Device>

As shown in FIG. 4, the electronic device 100 of the present embodiment includes the touch panel 130, the touch panel controller 131, the vibration parts 140, a vibration controller 141, the display panel 160, the display controller 161, the microcomputer 200, a ROM 210, a RAM 220, a communication section 230, and an I/O section 240.

The microcomputer 200 is a unit that controls the entirety of the electronic device 100, and is connected to various controllers. The ROM 210 has various types of programs stored therein. The RAM 220 has various types of data stored therein. The display controller 161 prepares data to be rendered, and controls the display panel 160 so as to display an image based on that data. The I/O section 240 inputs/outputs various types of signals.

The touch panel controller 131 controls operation of the touch panel 130. In a case where the touch panel 130 is of an electrostatic capacitance type, the touch panel controller 131 detects a change in electrostatic capacitance of the touch panel 130, and outputs, to the microcomputer 200, information of the position where the change has occurred, as touch position information. The vibration controller 141 receives the touch position information from the microcomputer 200, and uses information of the change in the touch position of the user and a time period of the touch being made by the user, to control vibration of the vibration parts 140 in according to various input operations (touch operations) performed by the user.

The communication section 230 is connected to a wireless LAN such as Wi-Fi (registered trademark), for example, with mutual connectivity among a plurality of electronic devices authenticated. For the connection among electronic devices, a scheme of establishing connection via an external communication device such as an access point, or a P2P (wireless ad hoc network) connection being a scheme of directly establishing connection not via an external communication device may be used.

<Description of Vibration Part>

In the present embodiment, in order to provide the user with tactile sensation through vibration when the user has operated the touch panel 130, the vibration part 140 is attached to the outer peripheral portion of the rear face (face of the touch panel 130 facing the display panel 160) of the touch panel 130. The vibration part 140 causes the touch panel 130 to vibrate, thereby providing the user with tactile sensation. As the vibration part 140, from the viewpoint of responsiveness and the size, a piezoelectric element is used, for example.

It should be noted that the vibration part 140 is not limited to a piezoelectric element, and may be any member that can convert electrical energy to vibration energy, such as a linear actuator, a voice coil motor, an artificial muscle, or the like, and that has desired properties and a size.

The frequency, the amplitude, and the period of vibration when tactile sensation is presented upon operation of the touch panel 130 are controlled by the vibration controller 141. As the frequency of the vibration, a frequency of about 100 to 400 Hz which easily allows a person to feel tactile sensation is preferable.

In the present embodiment, the vibration parts 140 are respectively attached at two positions on the short-side sides of the touch panel 130, for convenience. However, a plurality of vibration parts may be respectively attached along both of a long side and a short side, or along the four sides.

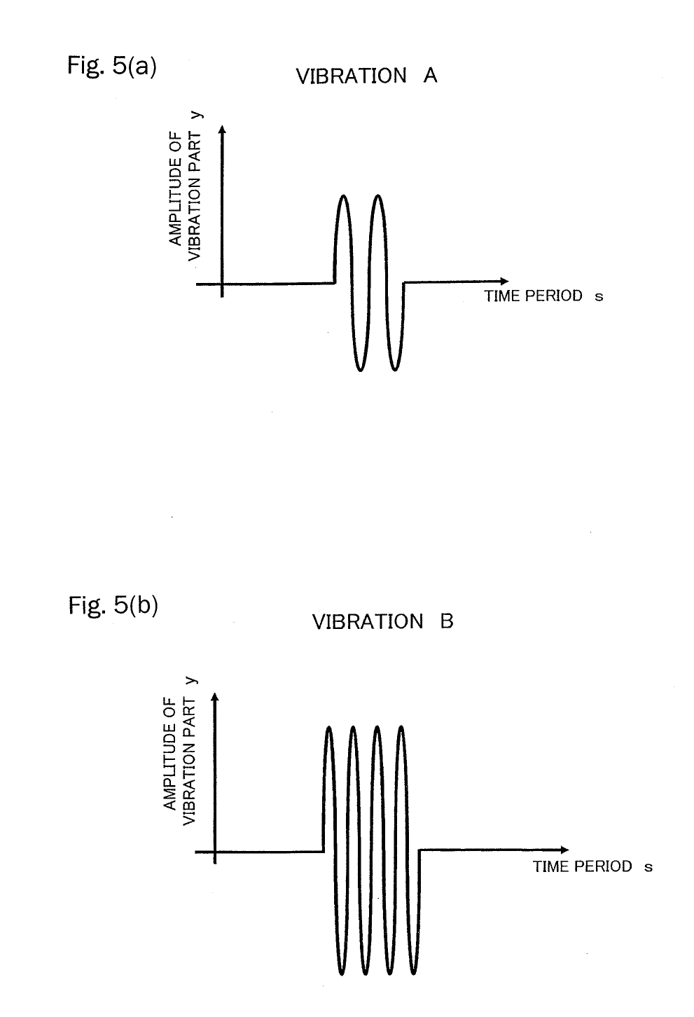

FIG. 5 is a schematic diagram showing examples of vibration patterns of the vibration part 140.

Upon receiving an instruction from the microcomputer 200, the vibration controller 141 applies a drive voltage to the vibration part 140, and causes the vibration part 140 to vibrate at the amplitude shown in FIG. 5(a), thereby causing the touch panel 130 to vibrate. Accordingly, vibration A is provided to the user. The drive voltage for providing the vibration A is in a sine wave, and for example, the frequency is 150 Hz, the root mean square value is 70 Vrms, and the applying period is 2 periods. The amplitude on the touch panel 130 is about 5 μm. Meanwhile, the vibration controller 141 applies a drive voltage to the vibration part 140, and causes the vibration part 140 to vibrate at the amplitude shown in FIG. 5(b), thereby causing the touch panel 130 to vibrate. Accordingly, vibration B is provided to the user. The drive voltage for providing the vibration B is in a sine wave, and for example, the frequency is 300 Hz, the root mean square value is 100 Vrms, and the applying period is 4 periods.

It should be noted that the frequency, the voltage value (root mean square value), the applying period are examples. The waveform of the drive voltage may be another waveform, such as a rectangular waveform, a saw tooth waveform, or the like, or alternatively, an intermittent waveform, or still alternatively, a waveform in which frequency and/or amplitude continuously change, or the like. Further, the magnitude of the amplitude on the touch panel 130 is an example, and the magnitude of the amplitude also changes depending on the conditions of the size or the supporting manner of the touch panel 130 and the display panel 160, the material or the shape of the adhesive layer 150, the number of the vibration parts 140, and the like.

<Effects>

As described above, the electronic device 100 in the present embodiment includes the display panel 160, the touch panel 130, the vibration parts 140, and the adhesive layer 150. The touch panel 130 is a member that is arranged so as to face the display panel 160 and to be touched by the user. The vibration parts 140 are attached to a face of the touch panel 130 facing the display panel 160, and cause the touch panel 130 to vibrate. The adhesive layer 150 is provided between the display panel 160 and the touch panel 130 so as to cover the vibration parts 140, and bonds the display panel 160 and the touch panel 130 together. In the present embodiment, the entirety of the vibration parts 140 is embedded in the adhesive layer 150, and sealed by the adhesive layer 150.

Accordingly, while bonding the touch panel 130 and the display panel 160 together, the adhesive layer 150 eliminates exposure of the vibration parts 140. Accordingly, without separately preparing a component for protecting (sealing) the vibration parts 140, breakage of the vibration parts 140 due to water drops and the like can be prevented, with a small number of components.

Further, the electronic device 100 of the present embodiment further includes the housing 105 which forms, in combination with the touch panel 130, space for housing the display panel 160. The housing 105 is composed of the upper housing 110 and the lower housing 120. The adhesive layer 150 extends further out than the outer periphery of the touch panel 130 and bonds the upper housing 110 to the touch panel 130.

Accordingly, the gap 115a between the outer peripheral surface of the touch panel 130 and the inner peripheral surface of the upper housing 110 is closed by the adhesive layer 150. Accordingly, without separately providing a component for dust-proof/drip-proof performance, entry of dust and water drops from the gap 115a into the inside of the electronic device 100 can be prevented.

### Embodiment 2

Next, an electronic device 300 of embodiment 2 will be described. The electronic device 300 of the present embodiment is different from that of embodiment 1 in the shape of the upper housing and the portion bonded by the adhesive layer. Hereinafter, the differences will be described.

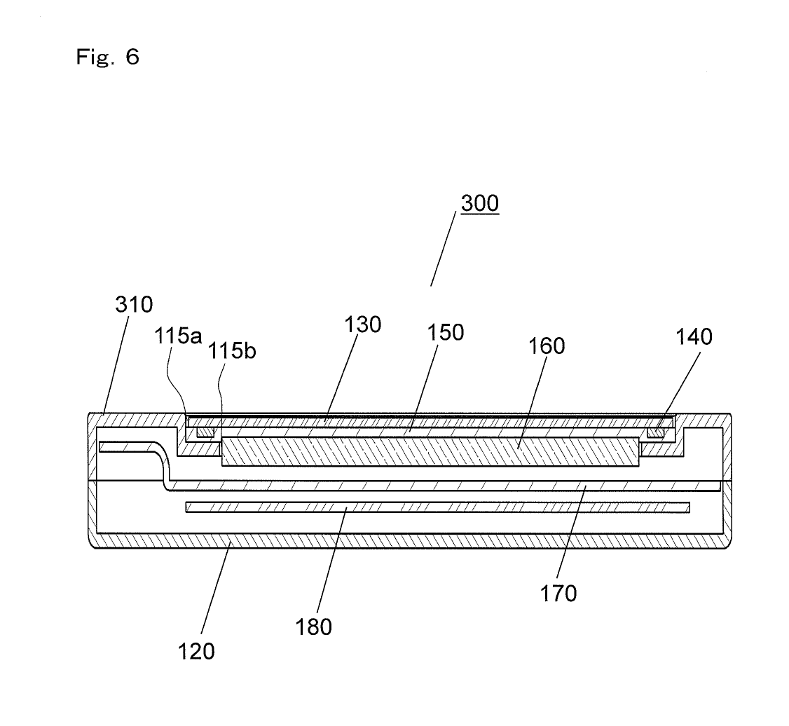

FIG. 6 is a cross-sectional view of the electronic device 300 of the present embodiment. As shown in FIG. 6, an inside portion of an upper housing 310 is bent downward and then bent rightward or leftward. The edge of the inside portion of the upper housing 310 extends to the rear side of the touch panel 130 and extends to near the outer peripheral surface of the display panel 160. Then, the touch panel 130, the display panel 160, and the upper housing 310 are integrally bonded together by the adhesive layer 150. Further, as in embodiment 1, each vibration part 140 is covered with the adhesive layer 150.

In the present embodiment, in addition to the gap 115a between the upper housing 310 and the outer peripheral surface of the touch panel 130, a gap 115b is also formed between the end face of the inside edge portion of the upper housing 310 and the outer peripheral surface of the display panel 160. However, since the adhesive layer 150 is formed so as to close the gap 115b, entry of dust and water drops from the gap 115b can be prevented. That is, dust-proof/drip-proof performance of the electronic device 300 can be realized by the adhesive layer 150.

Also with respect to the gap 115a, by the side face portion of the adhesive layer 150 and the upper housing 310 being in close contact with each other, the gap 115a can be closed.

### Embodiment 3

Next, an electronic device 500 of embodiment 3 will be described. The electronic device 500 of the present embodiment is different from that of embodiment 1 in that instead of the adhesive layer 150, a plate-like member 250 is interposed between the touch panel 130 and the display panel 160. Hereinafter, the difference will be described.

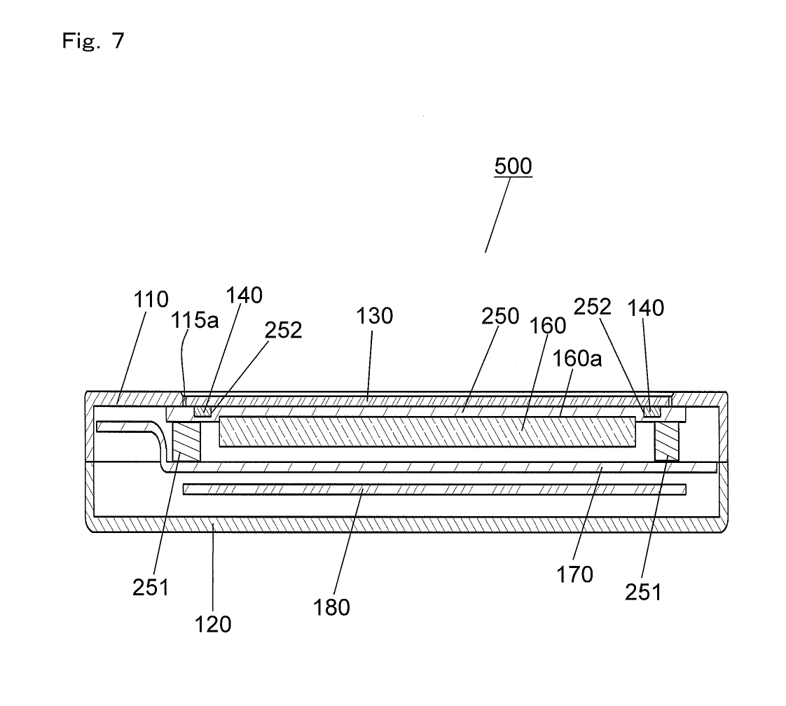

FIG. 7 is a cross-sectional view of the electronic device 500 of the present embodiment. As shown in FIG. 7, between the touch panel 130 and the display panel 160, the plate-like member 250 in which grooves 252 are formed corresponding to the respective vibration parts 140 is provided. The plate-like member 250 is sandwiched by the display panel 160 and the touch panel 130 such that the vibration parts 140 are sealed within the grooves 252, respectively. The plate-like member 250 and the touch panel 130 are bonded together at least around each vibration part 140. Therefore, without separately preparing a component for protecting (sealing) the vibration parts 140, breakage of the vibration parts 140 due to water drops and the like can be prevented, with a small number of components.

Further, for example, on the display panel 160 side of the frame 170, pressing members 251 for pressing the plate-like member 250 are provided. The pressing members 251 are arranged so as to be able to press portions, further out than the respective grooves 252, of the plate-like member 250.

In the present embodiment, the plate-like member 250 is sandwiched by the pressing members 251 and upper housing 110. The plate-like member 250 extends to the outside of the gap 115a, and is pressed against the upper housing 110 by the pressing members 251. Accordingly, the gap 115a is closed by the plate-like member 250. Therefore, without separately providing a component for dust-proof/drip-proof performance, entry of dust and water drops from the gap 115a into the inside of the electronic device 100 can be prevented. It should be noted that in a case where the touch panel 130 is fixed to the upper housing 110, portions, further out than the respective grooves 252, of the plate-like member 250 may be pressed against the touch panel 130 by the pressing members 251, thereby sealing the vibration parts 140 within the grooves 252, respectively.

Still further, the inner portion of the plate-like member 250 may be pressed against the touch panel 130, by using a cushion member such as silicone rubber, polyurethane rubber, or the like between the display panel 160 and the frame 170.

### Other Embodiments

As described above, embodiments 1, 2, and 3 have been described as examples of the technology disclosed in the present application. However, the technology in the present disclosure is not limited thereto, and can be applied to embodiments in which modifications, replacements, additions, and omissions are made as appropriate. A new embodiment can be made by combining various components described in embodiments 1, 2, and 3 above.

Hereinafter, other embodiments will be described as examples.

In embodiments 1, 2, and 3, the vibration parts 140 are arranged outside the display panel 160. However, if the thickness of the vibration parts 140 can be made thin relative to the thickness of the adhesive layer 150, the vibration parts 140 may be arranged between the touch panel 130 and the display panel 160. However, in such a configuration, it is preferable that the vibration parts 140 are arranged so as not to overlap the display surface 160a. For example, the vibration parts 140 may be directly bonded to the outside portion of the display surface 160a in the front face on the touch panel 130 side of the display panel 160. In this case, the vibration parts 140 are attached to a face of the touch panel 130 facing the display panel 160, by the adhesive layer 150.

As presented above, embodiments have been described as examples of the technology according to the present disclosure. For this purpose, the accompanying drawings and the detailed description are provided.

Therefore, components in the accompanying drawings and the detailed description may include not only components essential for solving problems, but also components that are provided to illustrate the above described technology and are not essential for solving problems. Therefore, such inessential components should not be readily construed as being essential based on the fact that such inessential components are shown in the accompanying drawings or mentioned in the detailed description.

Further, the above described embodiments have been described to exemplify the technology according to the present disclosure, and therefore, various modifications, replacements, additions, and omissions may be made within the scope of the claims and the scope of the equivalents thereof.

What is claimed is:

1. An electronic device comprising:
a display part;
a panel member arranged so as to face the display part and touched by a user;
a vibration part attached to the display part side of the panel member or to the panel member side of the display part, and configured to cause the panel member to vibrate; and
an adhesive part provided between the display part and the panel member so as to cover the vibration part, and bonding the display part and the panel member together.

2. The electronic device according to claim 1, further comprising:
a housing which houses the display part in combination with the panel member, wherein
the adhesive part extends further out than an outer periphery of the panel member and bonds the housing to the panel member.

3. The electronic device according to claim 1, wherein
an entirety of the vibration part is embedded in the adhesive part.

4. The electronic device according to claim 1, wherein
the display part includes a display surface on which to display information, and
the adhesive part is formed so as to cover at least an entirety of the display surface.

5. The electronic device according to claim 1, wherein
the adhesive part is formed from a material that allows light emitted from the display surface to pass therethrough.

6. The electronic device according to claim 1, wherein
the vibration part is formed from a piezoelectric element.

7. An electronic device comprising:
a display part;
a panel member arranged so as to face the display part and touched by a user;
a vibration part configured to cause the panel member to vibrate; and
a plate-like member in which a groove into which the vibration part is fit, the plate-like member being sandwiched by the display part and the panel member such that the vibration part is sealed within the groove.
